(19) United States
(12) Patent Application Publication
(10) Pub. No.: US 2024/0199203 A1
(43) Pub. Date: Jun. 20, 2024

(54) FLIGHT BODY, LANDING METHOD, AND PROGRAM

(71) Applicant: AERONEXT INC, Shibuya-ku (JP)

(72) Inventor: Yoichi SUZUKI, Tokyo (JP)

(21) Appl. No.: 18/554,767

(22) PCT Filed: Apr. 14, 2021
(86) PCT No.: PCT/JP2021/015474

§ 371 Date: Oct. 10, 2023

(51) Int. Cl. B64C 27/26

(52) U.S. Cl. CPC B64C 27/26

(57) ABSTRACT

A landing method for a flight body capable of achieving both vertical takeoff and landing and improving fuel consumption while improving landing performance. A flight body, comprising: a plurality of rotary wing parts that generate at least lift; a thrust drive device; and a fixed wing, wherein the thrust drive device generates thrust on the opposite side of horizontal flight during landing. Furthermore, the thrust drive device is equipped with a propeller, which, when landing, rotates in the opposite direction to that of horizontal flight. Furthermore, the thrust drive system generates more thrust to the opposite side during an emergency crash than during a landing.

### TECHNICAL FIELD

This invention relates to flight bodies, landing methods, and programs.

### BACKGROUND ART

In recent years, research and demonstration tests have been conducted for the practical application of services using flight bodies such as unmanned and manned drones and unmanned aerial vehicles (UAVs) (hereinafter collectively referred to as “flight bodies”). Flight bodies equipped with multiple rotor blades, commonly called multicopters (hereinafter collectively referred to as “multicopters”), do not have fixed wings, so they must constantly generate lift by using their rotor blades, which makes it desirable to improve their fuel efficiency.

In light of this situation, for example, in Patent Literature 1, in order to achieve both vertical takeoff and landing and improved fuel efficiency, a multicopter mechanism and fixed wings are combined to use the rotor blades of the multicopter mechanism for vertical takeoff and landing and hovering, and the lift generated by the main wings for horizontal flight. Thus, VTOL airframes (hereinafter collectively referred to as “conventional airframes”) have been developed with the aim of achieving both vertical takeoff and landing and improved fuel efficiency.

### PRIOR ART LIST

### Patent Literature

[Patent Literature 1] U.S. Ser. No. 10/131,426B2

### SUMMARY OF THE INVENTION

### Technical Problem

However, because conventional airframes, such as those illustrated in FIG. 18-FIG. 20 are designed so that a main wing 20 has an optimum angle of attack during horizontal flight, the main wing 20 may generate lift in the landing attitude, as shown in FIG. 20.

Thus, if the main wing 20 comprises an angle of attack that generates lift in an environment where the wind is blowing with a headwind component at the time of landing, the flight body may become unstable, and landing may be difficult. Depending on the strength of the wind, the flight body may unintentionally float upward as the main wing 20 generates lift due to the wind by assuming a landing posture, which may interfere with the descent operation for landing. In addition, flight bodies with a wing are generally equipped with a vertical tail wing to improve stability in the yaw direction. A flight body that gains a weathercock stability effect from the vertical tail will attempt to face the airflow, and the 20 main wing will be more likely to generate lift.

Therefore, one purpose of this invention is to provide a flight body that can achieve both vertical takeoff and landing and improved fuel efficiency by combining a multicopter mechanism and a main wing.

### Technical Solution

According to the invention, it is possible to provide a flight body, etc., equipped with a plurality of rotary wing parts that generate at least lift, a thrust drive device, and a fixed wing, wherein the thrust drive device generates thrust in the opposite direction during landing as during horizontal flight.

### Advantageous Effects

The invention provides a landing method that enables flight bodies to both achieve vertical takeoff and landing and improve fuel efficiency, and to improve landing performance.

### BRIEF DESCRIPTION OF THE DRAWINGS

FIG. 1 shows a conceptual view of a flight body according to the invention in cruise mode, viewed from the side.

FIG. 2 shows a top view of the flight body of FIG. 1.

FIG. 3 shows a front view of the flight body of FIG. 1.

FIG. 4 shows a functional block diagram of the flight body according to the invention.

FIG. 5 shows a side view of the flight body of FIG. 1 in landing mode.

FIG. 6 shows a side view of the flight body of FIG. 1 in landing mode.

FIG. 7 shows a view of the flight body in FIG. 6 when it receives wind from the nose direction.

FIG. 8 shows a side view of the flight body of FIG. 1 in landing mode.

FIG. 9 shows a side view of the flight body of FIG. 8 in landing mode.

FIG. 10 shows a top view of another flight body according to the invention.

FIG. 11 shows a top view of another flight body according to the invention.

FIG. 12 shows a top view of another flight body according to the invention.

FIG. 13 shows a top view of another flight body according to the invention.

FIG. 14 shows a top view of another flight body according to the invention.

FIG. 15 shows a side view of a flight body according to the invention showing examples of thrust drive unit connection angles.

FIG. 16 shows a side view of a flight body according to the invention showing examples of thrust drive unit connection angles.

FIG. 17 shows a side view of the flight body of FIG. 1 in emergency crash mode.

FIG. 18 shows a top view of a conventional aircraft.

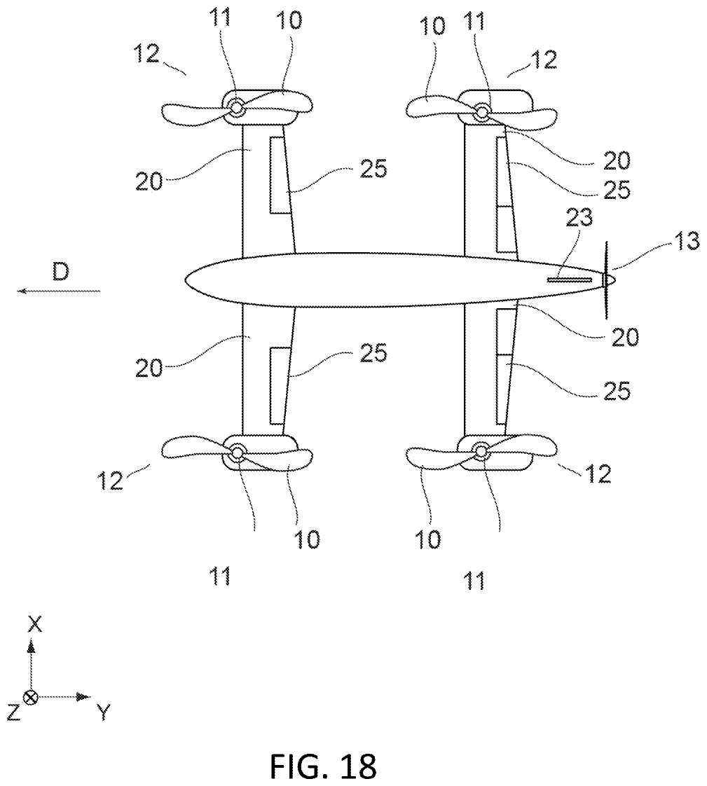

FIG. 19 shows a side view of the flight body shown in FIG. 18 when it is cruising.

FIG. 20 shows a view of the flight body shown in FIG. 18 when it receives wind from the direction of the nose.

### EMBODIMENT FOR IMPLEMENTING THE INVENTION

The following is a list and description of the contents of this embodiment of the invention. The flight body, landing method, and program according to this embodiment of the invention comprise the following.

### [Item 1]

A flight body, comprising:
a plurality of rotary wing parts that generate at least lift;
a thrust drive device; and
a fixed wing,
wherein the thrust drive device generates thrust on the opposite side during landing from that during horizontal flight.

### [Item 2]

The flight body according to item 1,
wherein the thrust drive device is equipped with a propeller,
wherein the propeller is to rotate in the opposite direction during landing as during horizontal flight.

### [Item 3]

The flight body as in item 1 or item 2,
wherein the thrust drive device generates more thrust to the opposite side during an emergency crash than during a landing.

### [Item 4]

A landing method for a flight body comprising a plurality of rotary wing parts that generate at least lift; a thrust drive device; and a fixed wing,
wherein the thrust drive device generates thrust on the opposite side during landing from that during horizontal flight.

### [Item 5]

A program that instructs a computer to execute a method of landing a flight body comprising a plurality of rotary wing parts that generate at least lift; a thrust drive device; and a fixed wing, wherein the thrust drive device generates thrust on the opposite side during landing from that during horizontal flight.

### DETAILED DESCRIPTION OF THE EMBODIMENTS

The following is a description of a flight body or the like according to this embodiment of the invention, with reference to the drawings. In the accompanying drawings, identical or similar elements are marked with identical or similar reference numerals and names, and duplicate descriptions of identical or similar elements may be omitted in the description of each embodiment. The features shown in each embodiment are also applicable to other embodiments as long as they do not contradict each other.

### Detailed of the First Embodiment

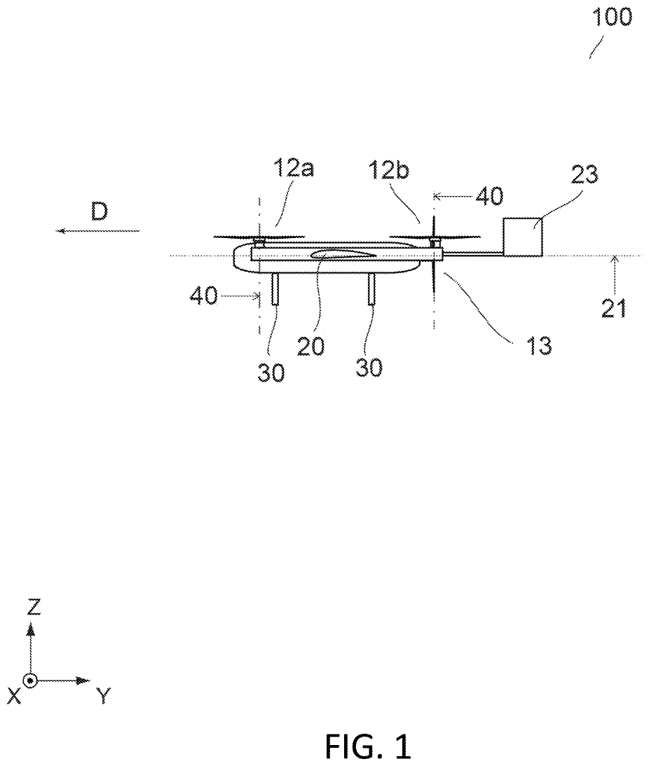

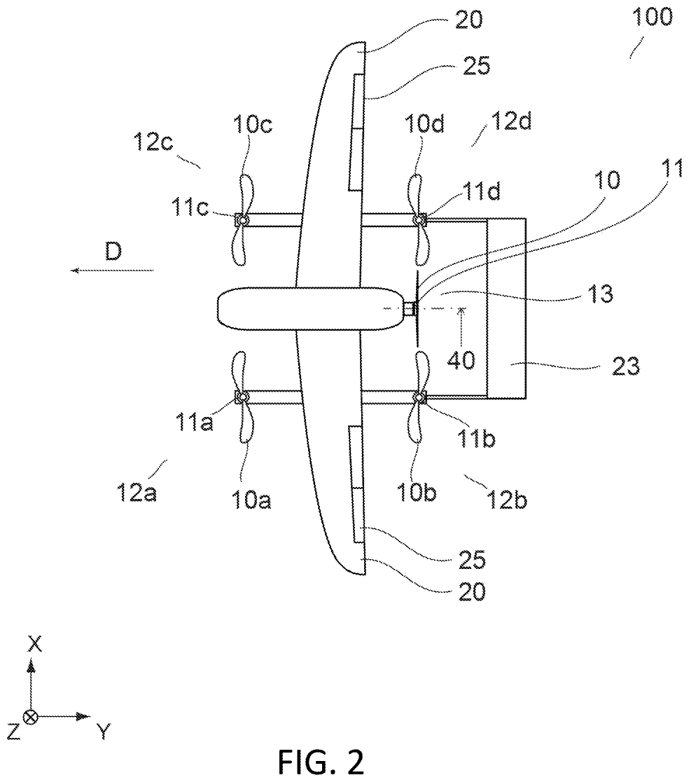

As shown in FIG. 1-FIG. 3, the flight body 100 according to this embodiment is a flight body capable of vertical takeoff and landing (VTOL). The flight body 100 is comprised of a lift generating part (including at least a rotary wing part 12 and a thrust drive device 13 that generate lift) comprising at least elements such as a propeller 10 and a motor 11, and a main wing 20 in order to perform the flight. The main wing 20 is connected directly or indirectly to the rotary wing part. The flight body 100 also has a landing leg 30 that make contact with the ground when landing. The flight body 100 shown in the figure is depicted in a simplified form to facilitate the description of the structure of the invention, and the detailed composition and internal structure of, for example, the control part, and the main body part of the airframe are omitted from the description.

The flight body 100 has at least one rotary wing part that serves as a thrust drive device (hereinafter collectively referred to as the thrust drive device 13) and at least two rotary wing parts 12 (four are shown in FIG. 1-3). The thrust drive device 13 is comprised to generate thrust in the horizontal direction. The rotary wing parts 12a-12d are configured to generate lift force acting vertically on the flight body 100 and may be specifically configured to generate lift force (lifting).

The thrust drive device 13 that propels the flight body 100 needs only to be capable of generating thrust in the horizontal direction during cruise. For example, it may comprise a rotary axis that can be tilted from horizontal to vertical so that it can be used with the rotary wing part 12 to generate lift during vertical takeoff.

The main wing 20 and thrust drive device 13 are set in a predetermined direction of the acting force. Therefore, the flight body 100 is directional. In particular, when the flight body is equipped with a wing intended to provide stability, such as a tail wing 23, the nose of the flight body tends to face upwind due to the wind stabilizing effect. Examples of the tail wing 23 include, but are not limited to, independent vertical and horizontal tail wings, as well as T-shaped, twin tail wings, and V-shaped wings.

The flight body 100 should be equipped with energy (e.g., secondary batteries, fuel cells, fossil fuels, etc.) to operate at least the rotary wing part 12 and the thrust drive device 13 that generate lift. The type of energy carried by the flight body may vary depending on the purpose of use; for example, the energy used to operate the rotor blades may be different from the energy used to operate the computers and sensors.

The main wing 20 is capable of generating lift to assist in the flight of the flight body 100. The main wing 20 may also be equipped with a dynamic blade 25 if necessary.

The landing leg 30 has a ground contact area that makes contact with the ground and may also be equipped with a damper or other devices that provide shock mitigation when landing or placing the flight body.

The flight body 100 is moving forward in the direction of arrow D (−Y direction) in figures (see below for details).

In the following explanation, the terms may be used according to the following definitions. Forward and backward: +Y and −Y, up and down (or vertical): +Z and −Z, left and right (or horizontal): +X and −X, forward direction (forward): −Y, rearward direction (backward) direction (backward): +Y direction, ascending direction (upward): +Z direction, descending direction (downward): −Z direction

The propulsion force is generated to take the flight body 100 off from the starting point, moving the body, and landing at the destination by doing so. The propeller 10 can rotate to the right, stop, and rotate to the left.

The propeller 10 provided by the flight body 100 of the invention has one or more blades. Any number of blades (rotors) (e.g., 1, 2, 3, 4, or more blades) is acceptable. The shape of the blades can be any shape, such as flat, curved, kinked, tapered, or a combination thereof. The shape of the blades can be changeable (e.g., stretched, folded, bent, etc.). The blades can be symmetrical (having identical upper and lower surfaces) or asymmetrical (having differently shaped upper and lower surfaces). The blades can be formed into airfoils, wings, or any geometry suitable for generating dynamic aerodynamic forces (e.g., lift, thrust) when the blades are moved through the air. The geometry of the vane can be selected as appropriate to optimize the dynamic aerodynamic characteristics of the vane, such as increasing lift and thrust and reducing drag.

The propeller provided by the flight body of the invention may be but is not limited to, a fixed pitch, a variable pitch, or a mixture of fixed and variable pitch.

The motor 11 produces the rotation of the propeller 10; for example, the drive device can include an electric motor or engine. The blades can be driven by the motor and rotate around the axis of rotation of the motor (e.g., the long axis of the motor).

The blades can all rotate in the same direction or can rotate independently. Some of the blades rotate in one direction while others rotate in the other direction. The blades can all rotate at the same RPM, or they can each rotate at a different RPM. The number of rotations can be determined automatically or manually based on the dimensions of the moving object (e.g., size, weight) and control conditions (speed, direction of movement, etc.).

The flight body 100 determines the number of revolutions of each motor and the angle of flight according to the wind speed and direction by means of a flight controller, a radio/propo, or the like. This allows the flight body to perform moving objects such as ascending and descending, accelerating and decelerating, and changing direction.

The flight body 100 can fly autonomously according to routes and rules set in advance or during the flight, or by using a radio/propo to control the flight.

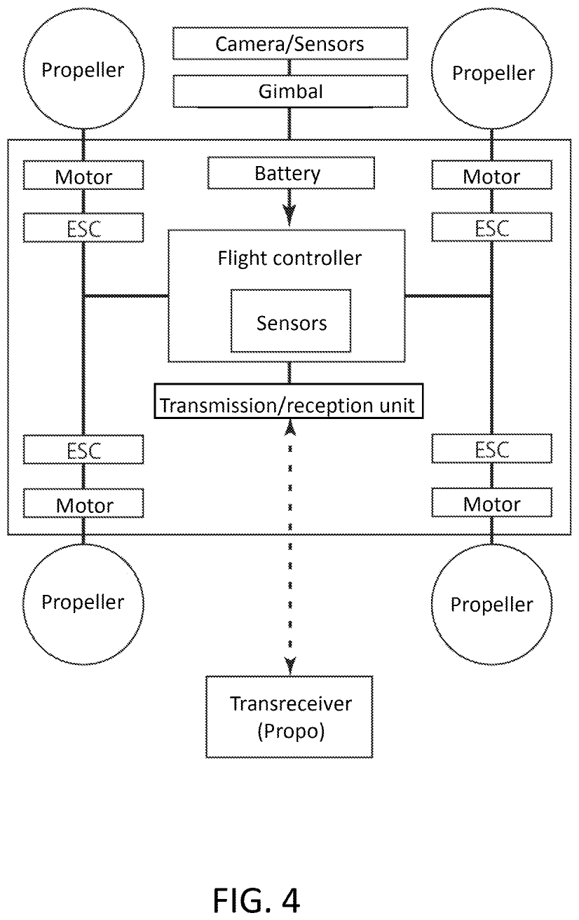

The flight body 100 described above has the functional blocks shown in FIG. 4. The functional blocks in FIG. 4 are a minimum reference configuration. The flight controller is a so-called processing unit. The processing unit can have one or more processors, such as a programmable processor (e.g., central processing unit (CPU)). The processing unit has a memory, not shown, which is accessible. The memory stores logic, code, and/or program instructions that can be executed by the processing unit to perform one or more steps. The memory may include, for example, a separable medium such as an SD card, random access memory (RAM), or an external storage device. Data acquired from a camera and a sensor or the like may be directly transmitted to and stored in the memory. For example, still and moving image data captured by a camera or other device is recorded in the internal or external memory.

The processing unit includes a control module configured to control the state of the rotorcraft. For example, the control module controls the propulsion mechanism (e.g., motor) of the rotorcraft to adjust the spatial arrangement, velocity, and/or acceleration of the rotorcraft having six degrees of freedom (translational motion x, y, and z, and rotational motion θx, θy and θz). The control module can control one or more of the states of a loading part and sensors or the like.

The processing unit is capable of communicating with a transmission/reception unit comprised of one or more external devices (e.g., terminal, display, or other remote controller) to transmit and/or receive data. The transreceiver can use any suitable means of communication, such as wired or wireless communication. For example, the transmission/reception unit can use one or more of the following: local area network (LAN), wide area network (WAN), infrared, wireless, WiFi, point-to-point (P2P) network, telecommunications network, or cloud communications. The transmission/reception unit can transmit and/or receive one or more of the following: data acquired by sensors or the like, processed results generated by the processing unit, predetermined control data, and user commands from a terminal or remote controller.

Sensors or the like in this embodiment can include inertial sensors (accelerometers, gyroscopes), GPS sensors, proximity sensors (e.g., lidar), or vision/image sensors (e.g., cameras).

As illustrated in FIG. 1, the flight body 100 in the invention can be expected to improve fuel efficiency during cruise mode by utilizing not only the propulsive force generated by the thrust drive device 13 but also the lift force generated by the main wings 20.

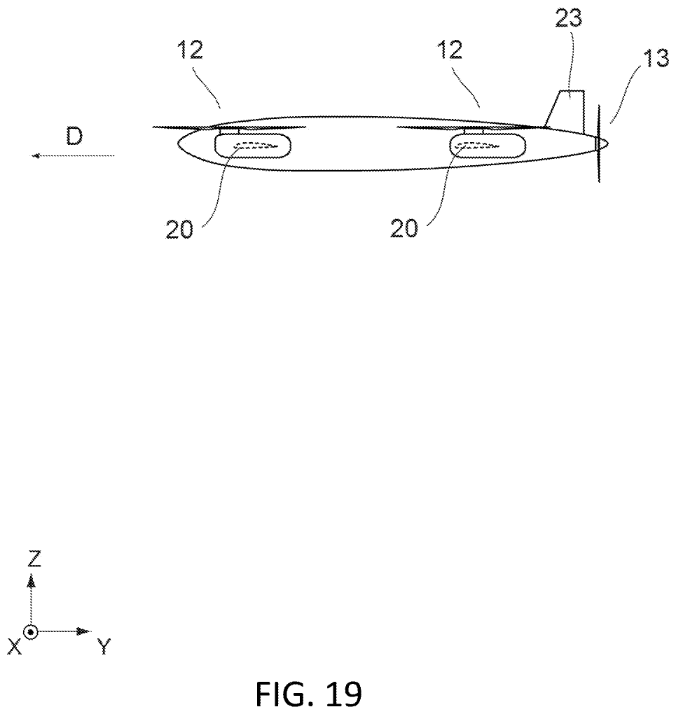

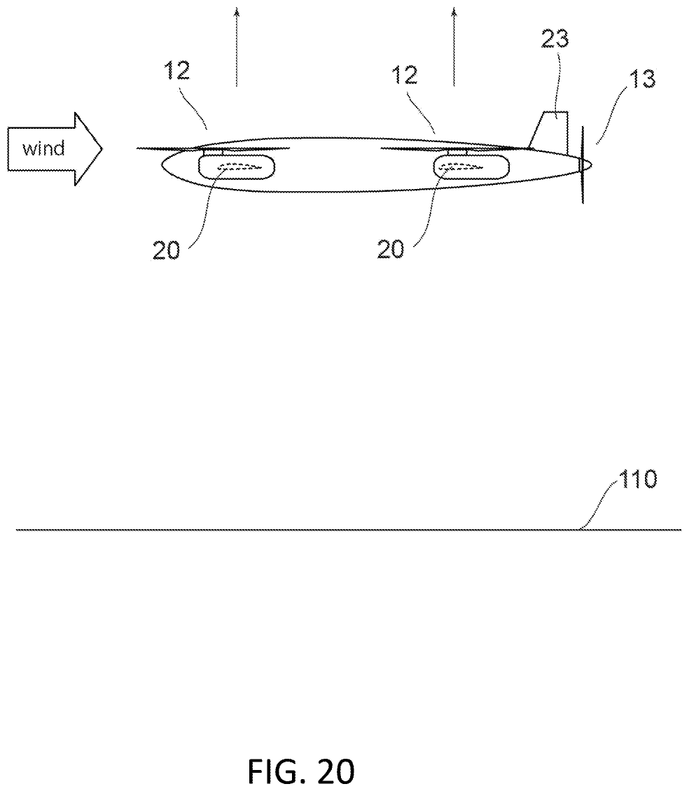

Here, the conventional aircraft will be explained again. As shown in FIG. 19 and FIG. 20, the conventional aircraft comprises no change in the angle of attack of the main wing 20 when the attitude of the main wing 20 in cruise mode is compared with that of the main wing 20 in landing mode.

The lift produced by the wing 20 increases as the angle of attack tilts in the positive direction until the stall angle of attack is reached. In addition, when the angle of attack is tilted in the negative direction, many wings can generate positive lift even when the angle of attack is 0 degrees, and even when the angle of attack is negative for some wing types, they may generate positive lift up to a predetermined angle, although the lift generated is smaller than when the angle of attack is 0 degrees or greater. Therefore, in a flight body configuration such as the conventional aircraft, where the 20 wings in landing mode are angled to generate lift as easily as in cruise mode, landing may take longer or be more difficult, or the aircraft may lift off the ground in strong winds. Especially in cases where efficiency-oriented operation is desired, such as in the home delivery business, the increased time required for landing and the frequent occurrence of cases where landing is impossible may hinder operation.

In particular, in a flight body equipped with a tail wing 23, a main wing 20 is more likely to generate lift when hovering, etc., because the nose of the airframe tends to face upwind without control.

Since the wing 20 does not generate lift if there is no airflow, it is unlikely that the lift generated by the wing 20 will affect landing if there is no or light wind. However, it is difficult to always have no or weak wind in the actual flight body landing environment.

In the flight body 100 according to the invention, the lift force generated by the main wing 20 in the landing mode is designed to be less than the lift force generated by the main wing 20 in horizontal flight in order to enable a stable landing in an environment affected by wind, such as outdoors, and to enable landing in strong winds, which are difficult for conventional aircraft to land.

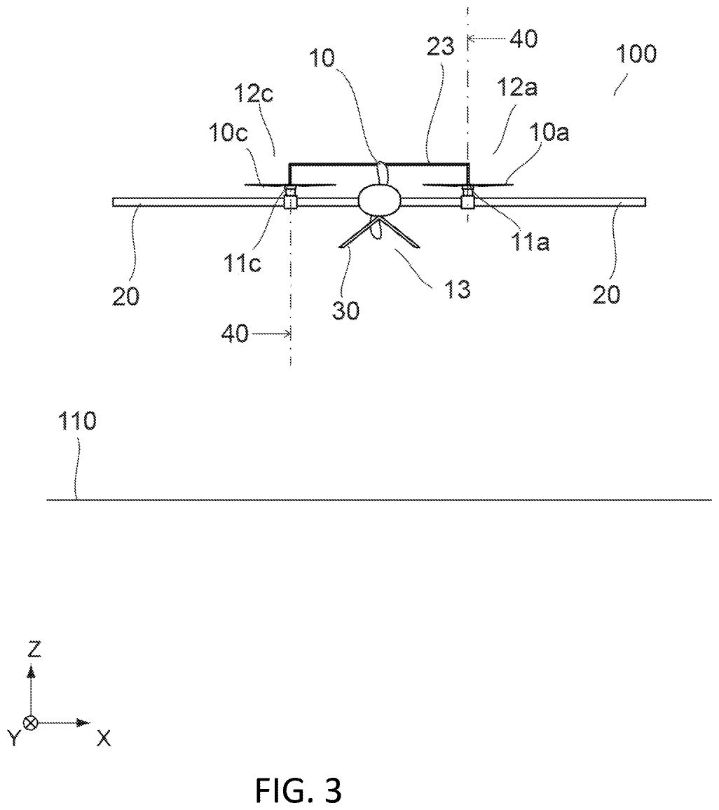

As illustrated in FIG. 1 and FIG. 3, the first embodiment provides landing control to reduce the lift produced by the main wing 20 during vertical landing (hereinafter collectively referred to as “landing mode”) compared to the lift produced by the main wing 20 during cruise mode (horizontal flight).

When the flight body that has been moving forward or hovering switches to the landing mode, the flight body 100 is landing by means of control and operation including the procedures exemplified in (1)-(6) below.
(1) Reverse the direction of rotation of the motor 11 provided by the thrust drive device 13.
(2) Reduce the rotational speed of the rotary wing parts 12a-12d and perform a vertical descent.
(3) The motor 11 of the thrust drive device 13 and the propeller 10 connected to it rotate in the opposite direction, generating thrust on the opposite side from the cruise mode, and the flight body 100 is pulled backward.
(4) The flight body 100 tilts forward by controlling the rotary wing parts 12a-12d in order to stay at a predetermined position (e.g., above the landing site) against the force pulling it backward. As a result, the angle of attack 21 of the main wing 20 becomes negative.
(5) The angle of attack 21 of the main wing 20 of the flight body 100 is more negative in the landing mode than in the cruise mode, and the lift generated is reduced.
(6) The flight body 100 lands on the landing surface 110.

The control method described above for the vertical descent of the flight body 100 is not limited, and any known control method can be employed, but it is desirable that the control method be one that allows the flight body in the sky to land without damage.

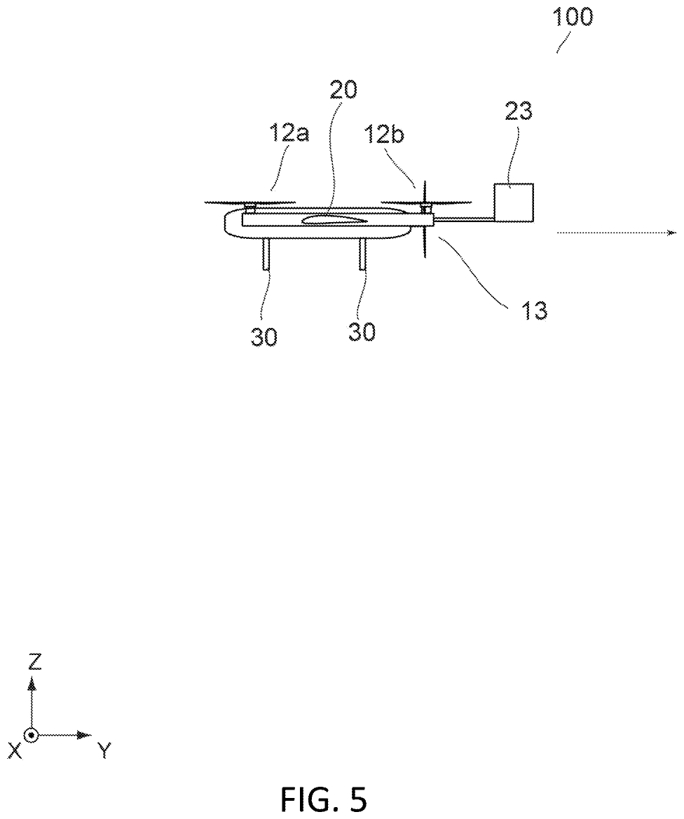

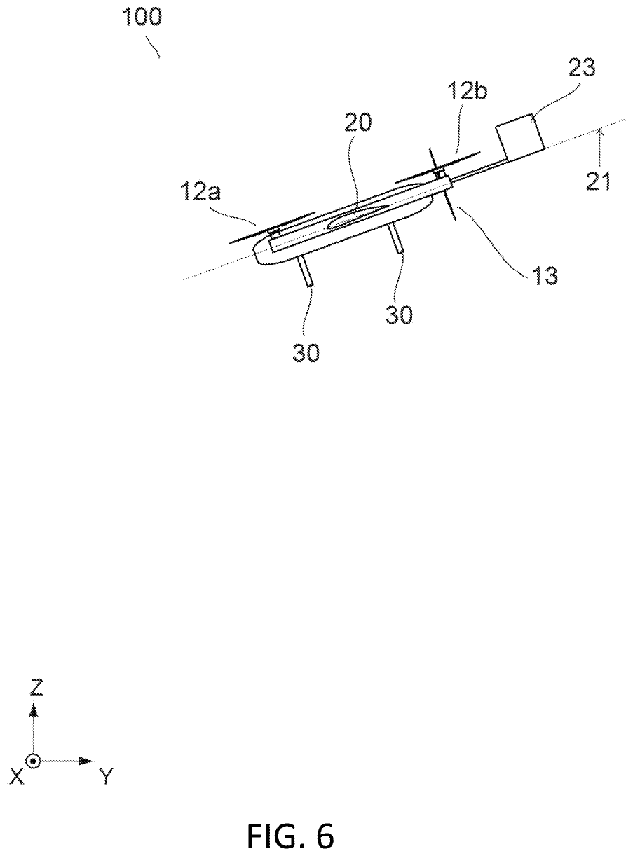

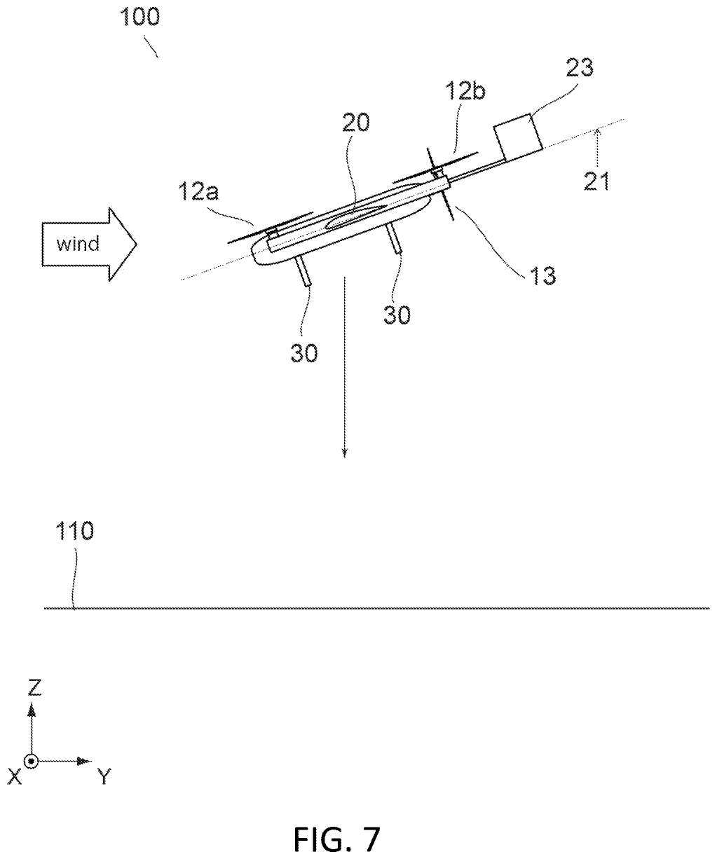

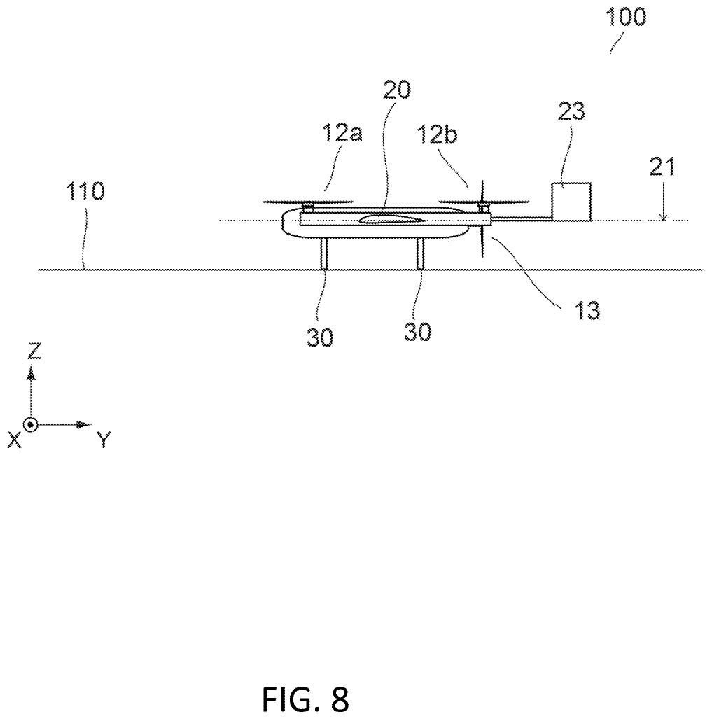

As shown in FIG. 5-FIG. 8, during the landing mode, the propeller 10 provided by the thrust drive device 13 is controlled to rotate in reverse, thereby controlling the airframe so that the angle of attack of the main wing 20 is in the negative direction, reducing the upward lift generation that prevents landing. This enables the flight body 100 to shorten the time required for landing and to improve the upper limit of wind speed at which landing is possible.

In the above configuration, the angle of the main wing during the landing mode is determined by the output of the thrust drive device 13. The output of the thrust drive device 13 may be controlled by a calculation process to achieve a suitable angle of the main wing 20 based on the relationship between the rotation axes angles of the rotary wing parts 12a-12d and the main wing 20, and data such as wind direction and wind speed during landing.

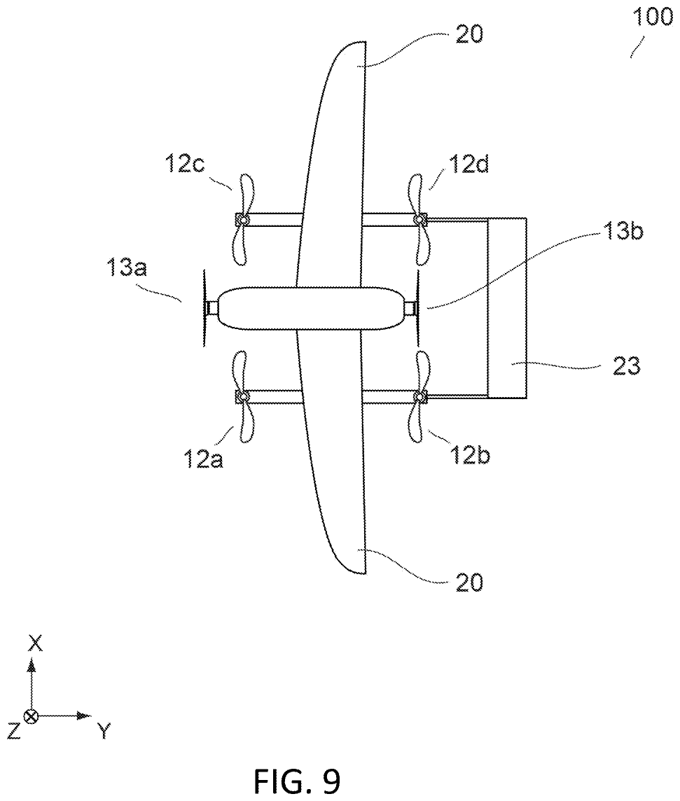

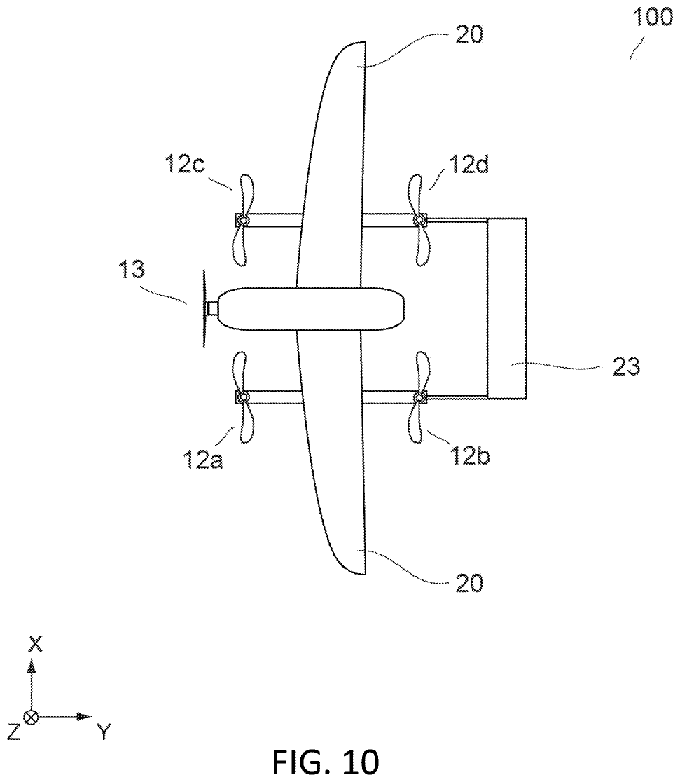

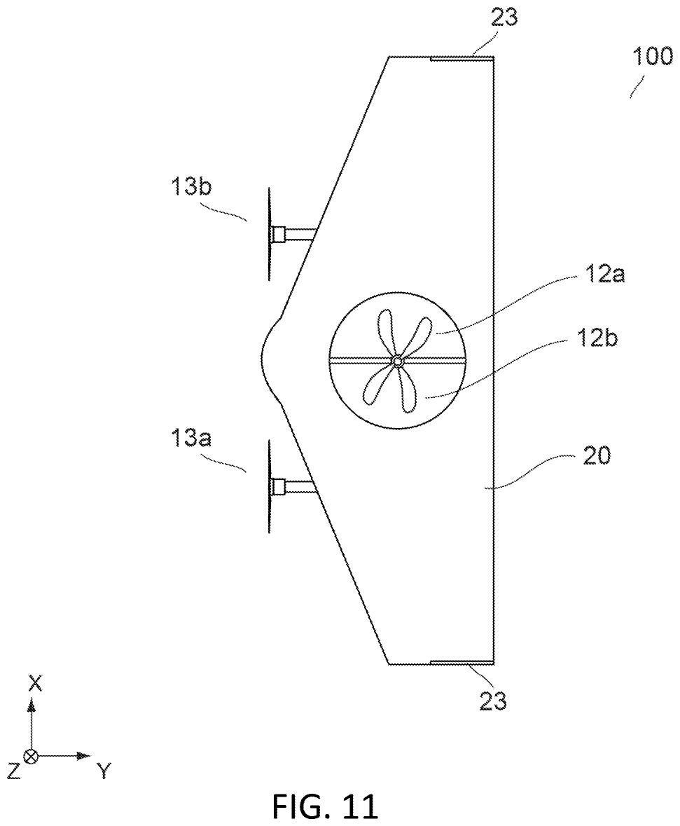

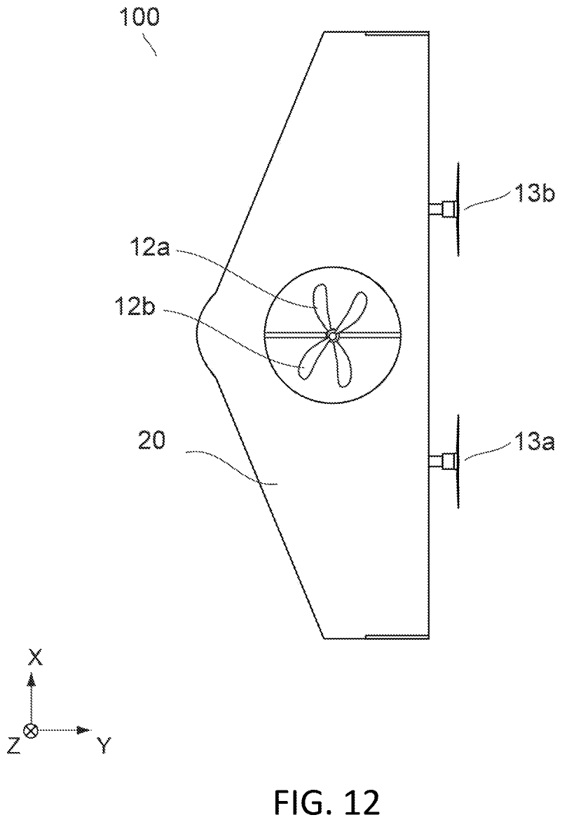

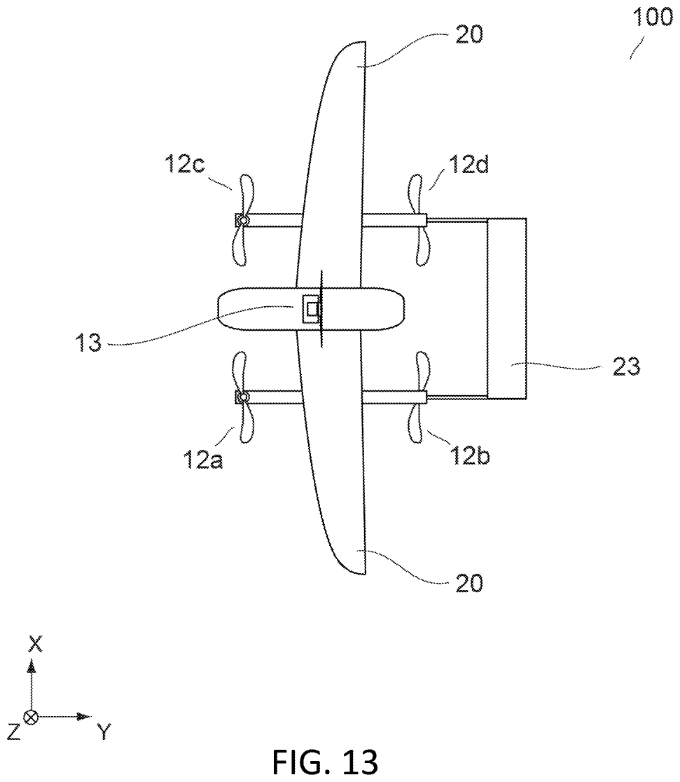

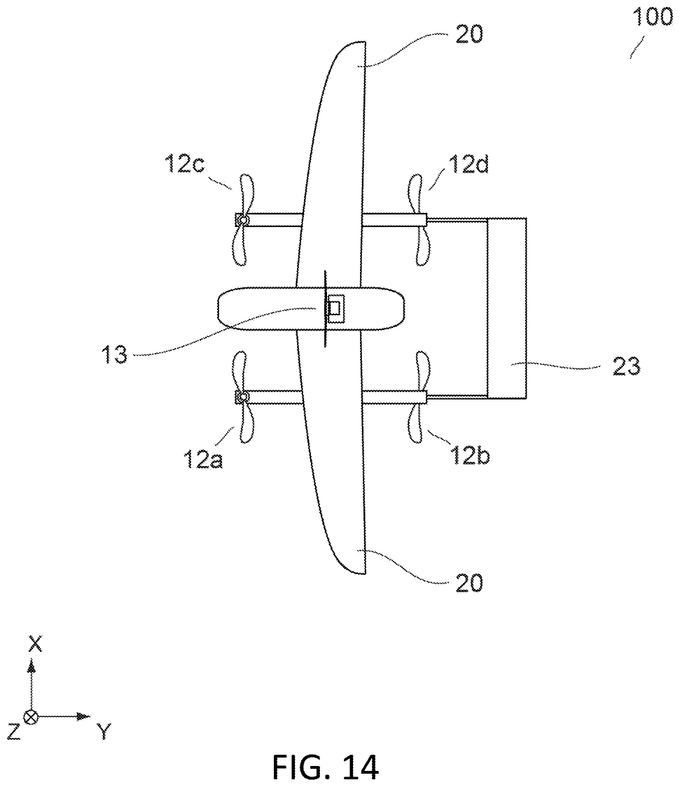

As shown in FIG. 9-FIG. 14, the location of the thrust drive device 13 provided by the flight body 100 is determined by the application and characteristics of the flight body. The connection position may coincide with the center of the flight body or be offset from the center in one or more of the following directions: upward, downward, forward, backward, to the right, or to the left.

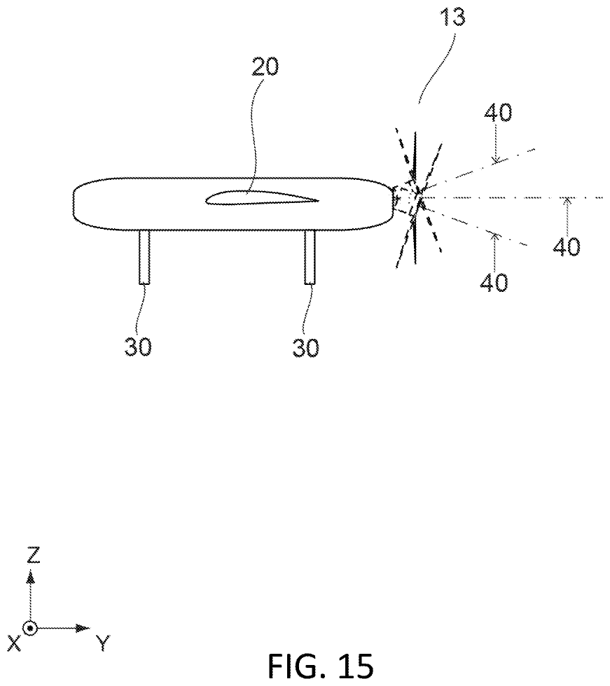

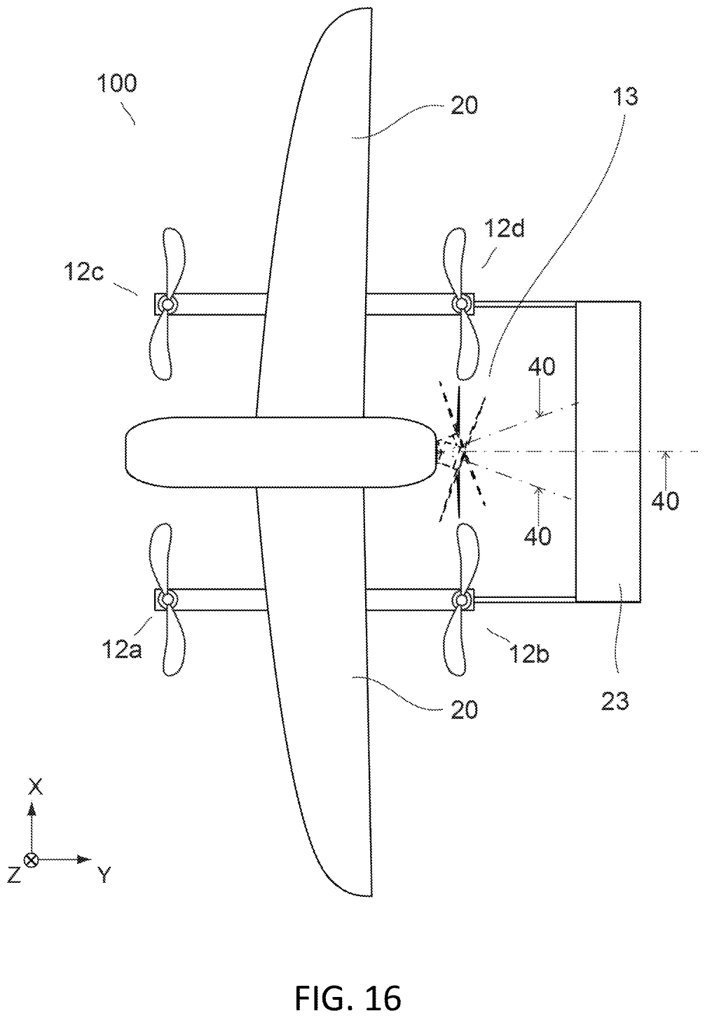

As shown in FIG. 15 and FIG. 16, the thrust direction of the thrust drive device 13 is also determined as follows: yaw is horizontal to the pitch axis, above the horizontal direction, below the horizontal direction, center, right, left, etc. to the yaw axis.

In a flight body with multiple rotary wing parts 12 and thrust drive devices 13, the connection position and thrust direction of each of the rotary wing parts may or may not coincide.

### Details of the Second Embodiment

In the details of the second embodiment of this invention, the components that overlap with those of the first embodiment operate in the same manner, so they will not be described again.

By reversing the rotation of the thrust drive device 13, which serves as the thrust drive device, thrust is generated in the opposite direction from that of the cruise, causing the main wing 20 to be displaced to a negative angle of attack. In addition to improving landing performance during normal flight body landings, this control also allows the flight body to limit the crash range or make an emergency landing in case of a flight body 100 failure, for example.

A VTOL aircraft equipped with a main wing 20 that can generate lift has the advantage of improved fuel efficiency by utilizing the lift generated by the main wing, but it can also be difficult to limit the crash site because the aircraft will continue to glide forward even if the rotor blades stop rotating, such as when a flight body is disabled.

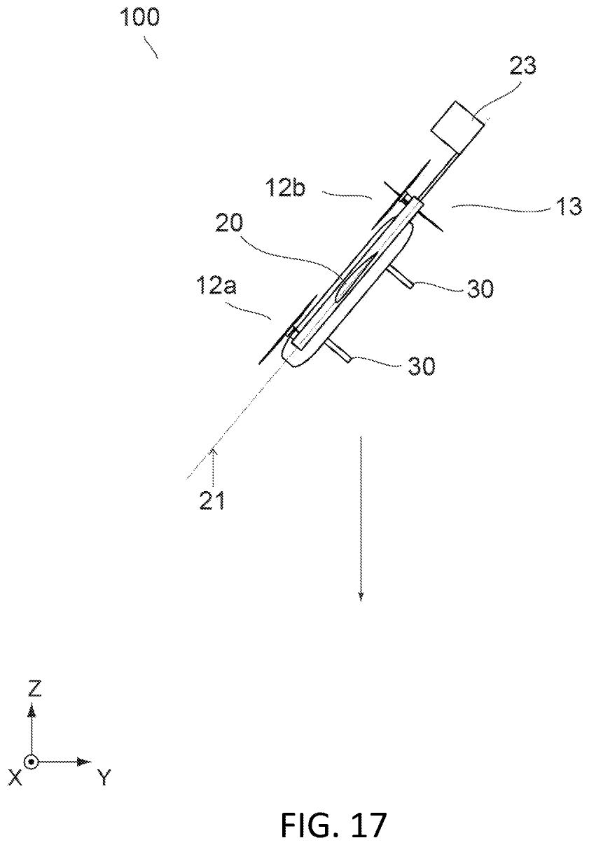

As shown in FIG. 17, in the emergency crash mode, the angle of attack 21 of the main wing 20 in flight is set to a strong negative angle of attack to actively stall the aircraft, rapidly lowering the altitude of the flight body 100 and forcing it to crash. For example, if the point where the anomaly occurred on the flight body 100 is a suitable location for an emergency crash site (e.g., an area with no human habitation or on the water), it is important to crash the aircraft on the spot more quickly before the aircraft moves over a human habitation or to a location where the damage from the aircraft fall would be extensive.

Conversely, if it is difficult to crash the aircraft at the point where the abnormality occurred, it is possible to prevent damage from the aircraft falling by leaving the site by gliding with the main wing 20 and switching to the emergency crash mode above a suitable point for the fall. When the flight body 10 falls, it is also possible to further reduce the impact on the point of fall by using a parachute or other means to reduce the fall speed.

If the negative or positive angle of attack of the wing 20 is increased to an angle that exceeds the stall angle during the emergency landing mode, the aircraft is expected to enter a stall and also to reduce its flight speed due to the increased drag of the wing 20.

For example, if an airfoil type that stalls at an angle of attack of −10 degrees is used for the main wing 20, (the angle of attack of the main wings is +5 degrees in cruise mode, 0 degrees in crash mode, and −20 degrees in emergency crash mode), a quick stall, crash, and fall in the emergency crash mode is possible.

The above-mentioned flight body 100 in each of the embodiments can be comprised of a plurality of configurations. It is desirable to comprise the appropriate configuration according to the cost of manufacturing the flight body and the environment and characteristics of the location where the flight body is to be operated.

The above mentioned embodiments are merely examples to facilitate understanding of the invention and are not intended to be construed as limiting the invention. It goes without saying that the invention may be changed and improved without departing from its purpose, and that the invention includes its equivalents.

### DESCRIPTION OF REFERENCE NUMERALS

10 (10a-10d) Propeller
11 (11a-11d) Motor
12 (12a-12e) Rotary wing part
13 (13a-13b) Thrust drive device
20 Main wing
21 Angle of attack of the main wing
23 Tail wing
25 Dynamic wing
30 Landing leg
40 Propeller axis of rotation
50 Cargo/load
60 Main body part
100 Flight body
110 Landing surface

1. A flight body, comprising:
a plurality of rotary wing parts that generate at least lift;
a thrust drive device; and
a fixed wing,
wherein the thrust drive device generates thrust on the opposite side during landing from that during horizontal flight.

2. The flight body according to claim 1,
wherein the thrust drive device is equipped with a propeller,
wherein the propeller is to rotate in the opposite direction during landing as during horizontal flight.

3. The flight body according to claim 1,
wherein the thrust drive device generates more thrust to the opposite side during an emergency crash than during a landing.

4. A landing method for a flight body comprising a plurality of rotary wing parts that generate at least lift; a thrust drive device; and a fixed wing,
wherein the thrust drive device generates thrust on the opposite side during landing from that during horizontal flight.

5. A non-transitory computer-readable storage medium storing a program that instructs a computer to execute a method of landing a flight body comprising a plurality of rotary wing parts that generate at least lift; a thrust drive device; and a fixed wing, wherein the thrust drive device generates thrust on the opposite side during landing from that during horizontal flight.

6. The flight body according to claim 2,
wherein the thrust drive device generates more thrust to the opposite side during an emergency crash than during a landing.
